(19) United States
(12) Patent Application Publication
(10) Pub. No.: US 2009/0034006 A1
(43) Pub. Date: Feb. 5, 2009

(54) STOCHASTIC HALFTONE IMAGES BASED ON SCREENING PARAMETERS

(76) Inventors: Daniel J. Blondal, Vancouver (CA); Lawrence Croft, Burnaby (CA)

Correspondence Address: David A. Novais;Patent Legal Staff, Eastman Kodak Company, 343 State Street, Rochester, NY, 14650-2201, US

(21) Appl. No.: 11/833,264

(22) Filed: Aug. 3, 2007

(51) Int. Cl. H04N 1/405

(52) U.S. Cl. 358/3.13; 358/3.06

(57) ABSTRACT

A method for processing an image includes a screen generator (31) which allows a user to define parameters (15) that determine the characteristics of a stochastic halftone screen (32). The screen generator (31) dynamically generates the screen (32) prior to an image processor (20) producing halftone image data (24) from the screen (32) and a supplied image (11). The screen generator (31) is based on an efficient parameterized algorithm whose parameters are selected to allow a user to easily customize a screen (32) that is suited for one of a wide range of reproduction processes.

### CROSS REFERENCE TO RELATED APPLICATIONS

Reference is made to commonly-assigned copending U.S. patent application Ser. No. ______ (Attorney Docket No. 94148/NAB), filed herewith, entitled METHOD FOR GENERATING A STOCHASTIC DITHER MATRIX, by Croft et al., the disclosure of which is incorporated herein.

### FIELD OF THE INVENTION

In the field of imaging, a halftone screen is used to convert a continuous tone image into a halftone image suitable for use with a halftone imaging device. The present invention relates to generating a stochastic screen and using that screen to reproduce halftone images representing the continuous tone image.

### BACKGROUND OF THE INVENTION

Halftone screens provide the appearance of varying tone by varying the number of enabled pixels in an area according to the desired tone. Two main types of screens are known in the art. Amplitude modulated (AM) halftone screens are one type wherein the size of a halftone dot increases as the desired tone increases. Stochastic or frequency modulated (FM) halftone screens are the other type wherein the number of halftone dots increases as the desired tone increases. Other types of screens, such as hybrid AM-FM screens are also known.

AM screens are further characterized by placing halftone dots on a grid having a screen angle and a screen frequency and increasing the size of a halftone dot according to a spot function (i.e. dot growth pattern) as the image tone increases in the area represented by the halftone dot. AM screening systems have traditionally allowed various characteristics, such as screen angle, screen frequency and spot function, to be specified by an end user to customize the screen effects. AM screening systems could then dynamically generate an AM screen based on the user input and apply that screen to a supplied continuous tone (contone) image.

User-defined AM screening has been practical for many reasons. One is because the relationship between control values and the screen result are generally easy to understand. Another is that many AM screens are computationally easy to generate. Also, because AM halftone dots comprise clustered pixels, the resulting halftone screens are relatively insensitive to variations in the image reproduction process.

For example, FIG. 1A depicts an exemplary AM halftone dot 3, comprising a plurality of enabled device pixels 2 on device pixel address grid 1, representing a 25% tone according to a user definition. FIG. 1B depicts a dot gain effect caused by a process variation that results in imaged device pixels 2 being 10% larger than expected. Note that dot gain for halftone dot 3 is less than 10% because parts of device pixels 2 overlap each other and thus not all of the pixel growth increases the overall area of halftone dot 3. FIG. 1C depicts the effect of a negative dot gain (dot loss) effect that results in imaged device pixels 2 being 10% smaller than expected. Note that dot loss at the perimeter of halftone dot 3 is less than 10% because some parts of device pixels 2 still overlap and thus not all of the pixel loss decreases the overall area of halftone dot 3.

The inherent dot gain in some print reproduction systems can be easily corrected to desired values by preprocessing the image data to vary the continuous tone values according to measured dot gain/loss characteristics of the reproduction process. This is known as dot gain compensation. Process variations can lead to similar shifts in dot area. However, it is often impractical to use tonal compensation to correct for variation. User screening controls, such as screen ruling have a significant impact on dot gain whereas screen angle and/or spot function, tend to have little impact on dot gain/loss. User screening controls also tend to have little impact on dot gain compensation methods.

Stochastic or FM screening is further characterized by halftone dots having a similar and small size (relative to most AM dots) distributed throughout an area represented by the stochastic screen. In contrast with AM screening, wherein halftone pixels cluster according to a spot function, a stochastic screen typically disperses halftone dots throughout an area.

Although finer stochastic screens generally have more visually pleasing characteristics than conventional AM screens, due to their finer structures and randomness, they tend to be more susceptible to variations in the image reproduction process. For example, FIG. 2A depicts a set of FM halftone dots 3, the set representing a 25% tone. Each FM halftone dot 3 comprises one enabled device pixel 2. FIG. 2B depicts the dot gain effect of a process variation that causes imaged device pixels 2 to be 10% larger than expected. Note that each halftone dot increases in size by 10% causing an approximate 10% tone increase. Similarly, in FIG. 2C, a 10% dot loss causes an approximate 10% tone reduction.

Worse, dot gain and other visual characteristics may not be consistent throughout the tonal range for some FM screens. For example, in the mid-tones, pixels dispersed in close proximity that suffer dot gain can begin to unintentionally cluster producing visible non-uniform structures and/or an overall uneven or grainy appearance in addition to a tone shift. A small shift in operating conditions for a reproduction process may result in a sudden onset of unwanted visual artifacts.

Prior art stochastic screen systems have employed predefined screens instead of user-defined screens. This is probably due to low demand and barriers such as complexity, usability and performance.

With respect to demand, stochastic screens have been prevalent for halftone imaging devices with relatively low resolution (i.e. device pixel size), and/or addressability (i.e. device pixel position), such as inkjet and xerographic reproduction systems. These systems typically have a limited number of supported operating conditions (e.g. resolution, colorants and paper) which can be characterized during the development of the system. User inputs may be typically limited to selecting a supported operating condition and/or a tradeoff between quality and speed. A predefined screen can be associated with an operating condition and/or user input combination to provide optimal results.

For higher resolution printing systems, such as offset, flexographic, and gravure printing systems, adoption of stochastic screens has been slow. Experience suggests that poor control over reproduction process operating conditions is a leading reason why printing firms fail to successfully adopt stochastic screens. For example, exposure non-uniformities, dot gain and poor ink transfer are more critical with finer screens and require tighter control over variations in plate sensitivity, exposure, developer strength, and printing press operating conditions, as well as with the formulation of the ink and paper it consumes.

Increased adoption rates for predefined screens have been achieved by teaching printing firms to monitor process variables and implement process controls to reduce their variation. Further, providing equipment and consumables that are less susceptible to process variation can simplify the printing firm's task. Further, some stochastic screens have characteristics that make them less susceptible to process limitations and variations than other stochastic screens.

As stochastic screening adoption rates have increased, the shortcoming of predefined screens is becoming apparent. Some printing firms have a range of reproduction processes that provide a large number of associated operating conditions. Also, each reproduction process may be subject to a different magnitude of variations in those operating conditions. A stochastic screen that is optimal for one operating condition may not be optimal for another.

For example, a new printing press that is routinely maintained may be able to reproduce fine screens without difficulty whereas an older printing press, in need of maintenance, may be unable to reliably reproduce fine screens without excessive effort. Since work done with finer screens is competitively advantageous, providing an optimal range of stochastic screens that can cater to a wider range of operating conditions is seen as beneficial. On the other hand, using an older printing press with less extensive process control may be more cost effective and coupling that with a stochastic screen that is less sensitive to variations in process operating conditions may allow the printer to produce differentiated printing at competitive costs. Providing end-user control of the screen design is preferable to enable creating a screen to match a particular reproduction process.

The prior art discloses a range of techniques for adapting stochastic screens for various operating conditions. For example, so-called blue-noise screens, disclosed in “Digital Halftoning” by Ulichney, 1987, and in U.S. Pat. No. 5,726,722 (Uehara et al.), produce highly dispersed dots with a relatively uniform but seemingly random distribution. These screens are characterized as having significant high frequency components that can be difficult to accurately reproduce for some reproduction processes. As another example, so-called green-noise or clustered screens, such as those disclosed in U.S. Pat. Nos. 5,784,049, 5,579,457 (both to Hall), and 6,493,112 (Arce et al.) seek to reduce the high-frequency component of blue-noise screens in the mid-tones by causing halftone dots to intentionally cluster rather than disperse. As another example, some prior art discloses modeling the halftone reproduction process when generating the screen to compensate for effects such as dot gain and dot overlap. As another example, some prior art discloses applying models of the human visual system when generating the screen to further reduce the visibility of halftone dot structure.

Given the emerging demand for a wider range of stochastic screens and preferably user-defined screens, several challenges still remain. One challenge is reducing the complexity of stochastic screens so that end users can understand how to match screen characteristics with a reproduction process. End users may easily grasp the characteristics of an AM screen and the relationship between those characteristics and some operating conditions. For example, a characteristic spot function and screen angle are visually intuitive and tend to have low correlation with certain operating conditions (e.g. good results over a wide range of resolutions, media sensitivities, exposure profiles, dot reproduction accuracies). Screen frequency is more correlated with operating conditions but the relationship is relatively simple (e.g. higher screen frequencies require reproduction processes that can more accurately resolve fine detail).

However, many end users may have difficulty understanding stochastic screen characteristics and their relationship with reproduction process operating conditions. For example, stochastic screens are traditionally characterized by one aspect such as their dot size at one point in the tone scale. However, the way in which the screen disperses dots throughout the tone scale affects how well the screen will be reproduced by a particular reproduction process.

Frequency domain characteristics of a screen are more useful in determining suitability for a reproduction process but they are less intuitive and are comparatively more complex and more variable for a stochastic screen than for an AM screen. For example, AM screens have power spectra based on the screen frequency and its harmonics. The power of the AM screen frequency component tends to dominate throughout the tone scale. In contrast, stochastic screens can have power spectra with more frequency components and with power spectra profiles that vary widely from screen to screen and/or vary at different points in the tone scale for the same screen.

Assuming that complexity challenges can be overcome, performance challenges also exist. Rather than performing relatively simple geometric operations as is the case for many AM screens, generating stochastic screens can involve complex spatial domain convolutions or frequency domain transforms, visual cost minimizations, and/or physical process modeling calculations. Thus, the computing resources and/or time required to dynamically generate a customized stochastic screen can be a problem. Given that current offset plate imaging times are on the order of a minute or two, end users would want to be able generate a stochastic screen within a few seconds or at most a minute or two so that significant imaging latency does not occur.

### SUMMARY OF THE INVENTION

The present invention provides a screen processor that can generate a wide range of stochastic screens to meet a wide range of operating conditions for one or more reproduction processes.

According to one aspect of the present invention, stochastic screens can be generated based on one or more parameters specified by an end user. An image processor can then produce halftone image data from contone image data based on the stochastic screen. A halftone imaging device can then optionally produce a halftone image on an imaging medium to represent the continuous tone image. The imaging medium (e.g. proof or plate) may be a final reproduction or may optionally be used by other halftone reproduction processes to produce multiple halftone image reproductions.

According to one embodiment of the invention, a dither matrix is dynamically generated by the screen processor and stored for later use in producing halftone image data. Multiple dither matrices can be generated with each matrix associated with one or more colors identified in the contone image data to provide a more visually pleasing halftone representation.

According to one embodiment of the invention, a dither matrix can take the form of a threshold array, including a matrix of threshold values wherein each threshold value can be used to determine a halftone pixel value by comparing a corresponding contone pixel value with a corresponding threshold value.

According to one embodiment of the invention, a dither matrix can take the form of a plurality of dot profiles wherein each dot profile represents a matrix of halftone pixel values for an area for a specified contone value. A halftone image pixel value can be determined by looking up a halftone value in a pixel position of a dot profile corresponding to a contone image pixel position and contone value.

According to one embodiment, the screen generator can dynamically produce dither matrices of varying dimensions (e.g. matrix of size N×M dimensions) and can produce them quickly enough so that latency in an imaging process is not substantially increased. For example, typically sized dither matrices (e.g. approximately 250,000 pixels) and large dither matrices (e.g. at least 1,000,000 pixels) can be generated quickly. In particular, dither matrices can be generated so that the time required to generate a dither matrix is proportional to the product of the dither matrix dimension and the natural logarithm of the dither matrix dimension. Further, the time required to generate a typically sized dither matrix is less than 1 second. In some embodiments, a newly generated screen can be cached for later use when the same screen generation parameters are used.

According to one embodiment of the invention, a parameterized algorithm controls generation of a stochastic screen. Screen generation parameters are configured by an end-user at an interface to the screen processor. The screen generation parameters either coincide directly with the algorithm parameters or can be used to derive values for the algorithm parameters. A customized screen is generated by providing parameter values to the screen generation algorithm. Screen generation parameters can be configured to produce predefined screens or can be dynamically configured by a user for an image, a job or some other collection of images.

According to one embodiment of the invention, the screen generator and image processor are coupled with a halftone imaging device which has sufficient accuracy to support a wide range of stochastic screens that can be generated. In particular, the halftone imaging device preferably has sufficiently high addressability and resolution to support the wide range of screens. For one exemplary imaging device, pixel addressability of at least 2400 DPI and halftone dot resolution at least 1200 DPI is preferred. For another exemplary imaging device, imaging addressability of at least 4800 DPI and imaging resolution of at least 2400 DPI is preferred.

According to one embodiment, reproducing an image from halftone image data includes one or more reproduction processes including at least one process having an element designed to be relatively insensitive to variations in the reproduction process so that a given screen has a greater probability of producing desired results. For example, the halftone imaging device can be designed to be relatively insensitive to variations in the imaging process.

According to one embodiment, a system can be configured to dynamically generate a halftone image having characteristics that respect a dimensional constraint. For example, screen size and image resolution can be dynamically configured to enable a portion of the halftone image to satisfy the constraint without compromising the visually pleasing properties of the halftone screen. Exemplary constraints include repeat length for a cylindrical imaging media and image segment dimension for a lenticular lens.

### BRIEF DESCRIPTION OF THE DRAWINGS

FIGS. 1A-1C illustrate the effect of dot gain variation on an AM screen.

FIGS. 2A-2C illustrate the effect of dot gain variation on a FM screen.

FIG. 3 illustrates an exemplary image reproduction process according to one embodiment of the present invention.

FIGS. 4A and 4B illustrate exemplary halftone dots for a highly addressable device pixel matrix according to one aspect of the present invention.

FIGS. 5A and 5B illustrate exemplary imaging device exposure profiles and their sensitivity to process variation according to one aspect of the present invention.

FIG. 6 is a flow chart diagram illustrating an exemplary method for generating a stochastic screen based on screening parameter values and a parameterized screening algorithm according to one embodiment of the present invention.

FIGS. 7A-7E illustrate an exemplary set of data structures used in generating a screen according to the present invention.

FIGS. 8A-8C illustrate exemplary data structures after selection of seed minority pixels according to one aspect of the present invention.

FIGS. 9A and 9B illustrate an exemplary data structure after application of an exemplary shaping function for a new minority pixel according to one aspect of the present invention.

FIG. 10 illustrates an exemplary graph of dot edge/area ratios for a stochastic halftone screen according to one embodiment of the present invention.

FIG. 11 illustrates an exemplary graph of dot edge/area ratios for a set of stochastic halftone screens with varying cluster shaping parameters according to one aspect of the present invention.

FIG. 12 illustrates exemplary graphs relating edge/area ratio values with cluster shaping parameter values according to one aspect of the present invention.

FIGS. 13A-13C illustrate exemplary data structures related to generation of halftone dots based on a cluster size parameter according to one aspect of the present invention.

FIGS. 14A and 14B illustrate an exemplary minority pixel dot gain model incorporated into the screen generator according to one aspect of the present invention.

FIG. 15A illustrates a first exemplary stochastic screen generated by default screen generation parameters according to one embodiment of the present invention.

FIG. 15B illustrates additional characteristic plots for the first exemplary screen of FIG. 15A.

FIGS. 16-23 illustrate additional exemplary stochastic screens based on exemplary screen generation parameters according to one embodiment of the present invention.

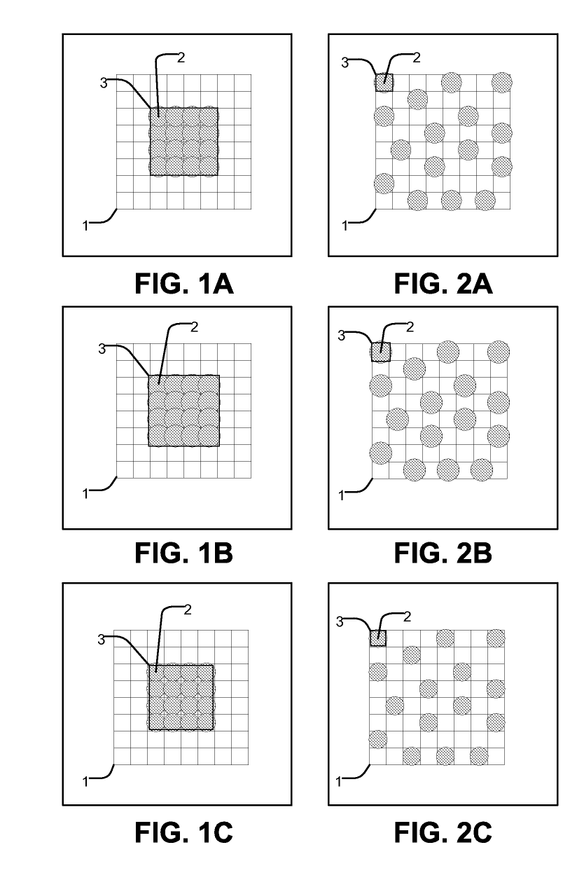

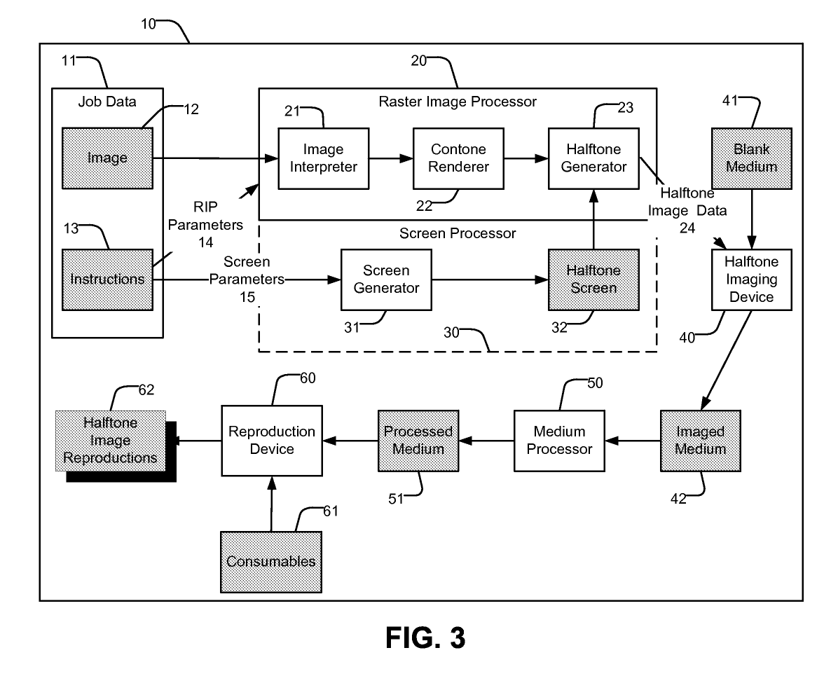

### DETAILED DESCRIPTION OF THE INVENTION

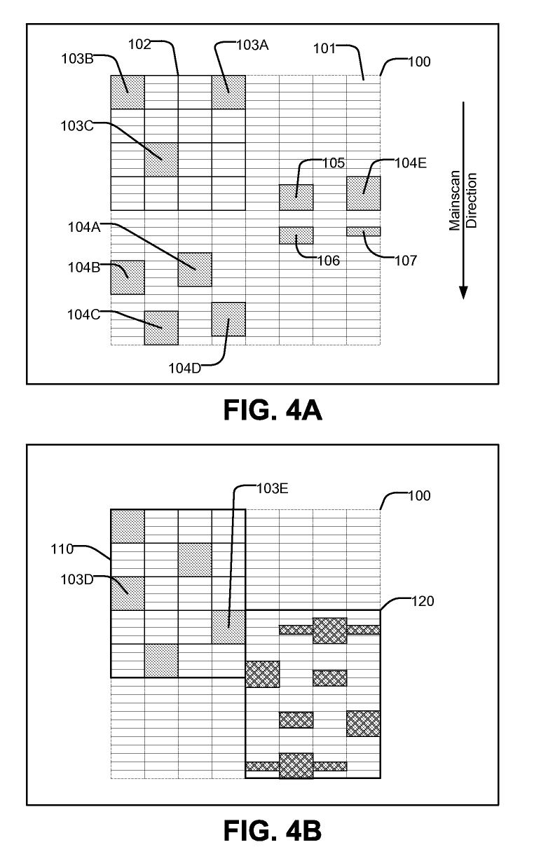

FIG. 3 illustrates an exemplary printing system 10 for performing an image reproduction process according to one embodiment of the present invention. Job data 11 includes one or more contone images 12 and processing instructions 13. Contone images 12 and parameters 14, derived from processing instructions 13, are provided to a raster image processor (RIP) 20. RIP 20 generates data corresponding to halftone image data 24 representing contone image 12. Halftone image data 24 is provided to halftone imaging device 40 which exposes halftone image data 24 on blank imaging medium 41 to produce imaged medium 42. Blank imaging medium 41 can be a film, lithographic plate, flexographic plate, gravure cylinder, thermal transfer receiver as examples.

Depending on the type of blank imaging medium 41, imaged medium 42 may be further processed by medium processor 50 to produce a processed medium 51. For example, a lithographic plate may require initial heating, chemical developing, final heating, mechanical processing or on-press developing as part of a post-imaging activity.

Again, depending on the type of blank imaging medium 41, imaged medium 42 or processed medium 51 may be the final product or may be used in a reproduction device 60, such as a printing press, to produce a plurality of halftone image reproductions 62 from consumables 61 such as paper stock and ink.

Job data 11 can be configured, for example, as part of a prepress workflow system which incorporates or feeds information to RIP 20. Job data 11 can include contone images 12 for multi-page documents whose contents are printed on one or both surfaces of a printed sheet (e.g. paper, cardboard, or metal foil). One or more images can be ganged together for printing on a surface and subsequent folding and/or cutting. An end-user may desire to screen each image independently (e.g. configure a screen for each image) or may desire to screen parts of an image independently. Thus, for any given print job, a plurality of halftone screens 32 may need to be generated.

Contone image 12 can include contone raster data and/or page description language specifying text, artwork and the like. Processing instructions 13 can include a wide variety of instructions related to prepress and other processing functions. Processing instructions 13 can include end-user configured screen parameters 15 which are used by screen generator 31 to produce halftone screen 32. Exemplary screen parameters 15 and screen generator 31 are described in greater detail below.

RIP 20 screens contone image 12 according to methods that are well understood in the art. Briefly, image interpreter 21 can first interpret image data (e.g. page description language) to produce data (e.g. object list) that contone renderer 22 can use to generate a consolidated contone raster representing image 12. Halftone generator 23 then applies halftone screen 32 to the contone raster to form halftone image data 24. Screen processor 30 can be a standalone processor or be part of RIP 20. In some embodiments, screen processor 30 can also be used independent of job 11 to produce halftone screens 32 for RIP 20.

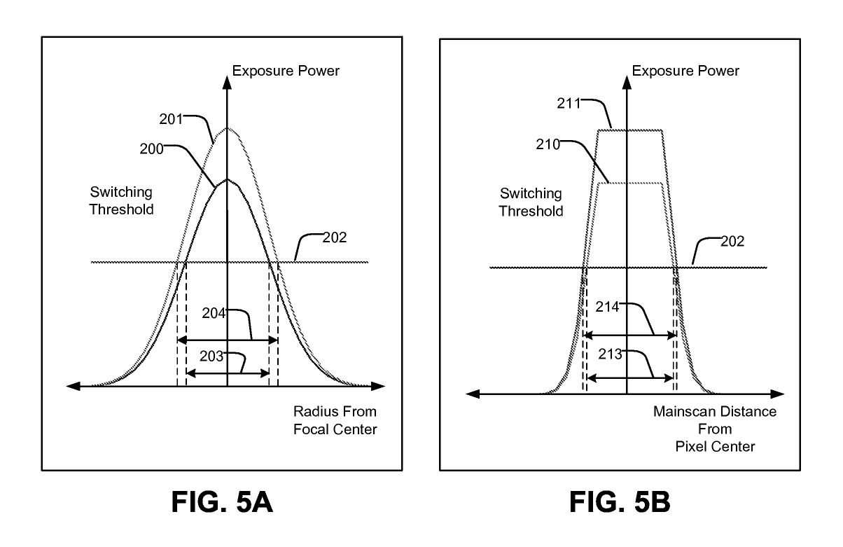

FIGS. 4A and 4B illustrate exemplary halftone dots for a highly addressable device pixel matrix 100 according to one embodiment of the present invention. For one exemplary halftone imaging device 40, device pixel matrix 100 includes device pixels 101 having an addressability of 9600 DPI in an imaging mainscan direction and 2400 DPI in an imaging subscan direction. Some models of the Magnus family of CTP devices, manufactured by Eastman Kodak, have this increased addressability.

Square halftone dot matrix 102 of FIG. 4A depicts 2400 DPI addresses for square halftone dots. Enabled halftone dots 103A-103C correspond to a portion of a stochastic screen and are depicted with dark shading. They illustrate halftone dots having 2400 DPI resolution with a separation of at least one halftone dot width. Although halftone imaging device 40 is capable of 9600 DPI addressability use of square dot resolution is common for many screens.

Enabled halftone dots 104A-104E depict a stochastic screen that takes partial advantage of the higher addressability. That is, halftone dots still have 2400 DPI resolution but are not restricted to positions on a 2400 DPI matrix. This can allow for greater enabled dot density while still maintaining some separation (e.g. one halftone dot width). Enabled halftone dots 105-107 illustrate a stochastic screen taking further advantage of higher addressability. That is, halftone dots have variable resolution (e.g. 1-4 device pixels) that allow even greater flexibility in representing a continuous tone while still retaining at least some separation between halftone dots.

FIG. 4B illustrates parts of two exemplary stochastic screens using halftone dots with different resolution and addressability characteristics. Area 110 includes five enabled halftone dots on a 2400 DPI matrix and represents a tone of 5/20 or 20%. Area 120 includes six irregularly shaped halftone dots with varying resolution that represent the same 20% tonality. The halftone dots of area 120 may provide a smoother screen and maintain greater separation than those of area 110 (e.g. dots 103D and 103E would touch if the screen of area 110 wraps around). If dot gain is greater than expected, a screen corresponding to area 110 may be more likely to cause visual artifacts from unexpected clustering than a screen corresponding to area 120. Thus, by taking advantage of increased addressability stochastic screens can be generated that are smoother and less sensitive to process variations.

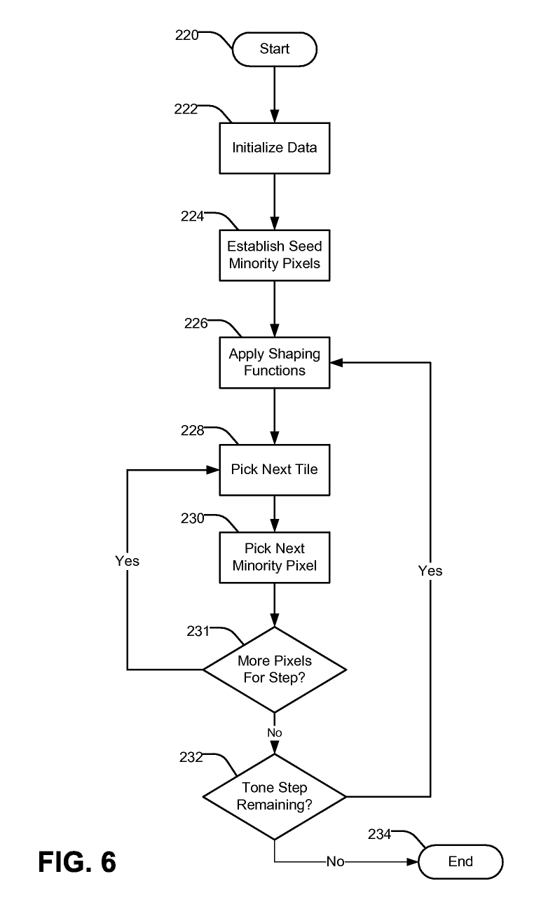

FIGS. 5A and 5B illustrate exemplary imaging device exposure power profiles and their sensitivity to process variation. FIG. 5A corresponds to a cross-section of a traditional round thermal laser spot which exhibits a Gaussian exposure power profile. A dot (e.g. 2400 DPI resolution) on blank imaging medium 41 is enabled by enabling the laser at a device pixel address. The dot is formed around the focal center of the laser spot where the exposure power is above a switching threshold 202 of blank imaging medium 41. For example, with a nominal Gaussian exposure profile 200, an approximately round halftone dot with nominal dot diameter 203 will be produced at the focal center. If, for example, the laser exposure power is higher (e.g. increased Gaussian exposure profile 201) or the media is more sensitive, a larger dot diameter 204 can result.

FIG. 5B corresponds to an exemplary laser spot which exhibits a nominal steep exposure profile 210 for a halftone dot. This can be accomplished, for example, by exposing using techniques such as those disclosed in commonly-assigned U.S. Pat. Nos. 6,121,996 and 6,266,080 (both to Gelbart), and incorporated herein by reference. In summary, an exposure spot can be shaped into a line which is swept in a mainscan direction. The spot has a line length corresponding to a device pixel subscan dimension (e.g. 2400 DPI) and a line width narrower than a device pixel mainscan dimension (e.g. at least 4800 or higher) so that sharp transitions occur at the device pixel edges. Thus, an approximately square dot (e.g. 2400 DPI) with mainscan dimension 213 is formed for nominal steep exposure profile 210. If the spot width is narrow enough, a rectangular (e.g. 2400 DPI×9600 DPI) dot can be formed with similarly sharp transitions. If the laser exposure power is higher (e.g. increased steep exposure profile 211), a dot with mainscan dimension 214 will be produced. Thus, a dot formed at a device pixel by a device with exposure power profile 210 exhibits less dot gain, for a change in exposure power or media sensitivity, compared to a dot formed by an imaging device with the nominal Gaussian exposure profile 200. In other words, such an imaging device may produce halftone dots that are less susceptible to reproduction process variations and thus are more likely to consistently produce visually pleasing images with finer screens.

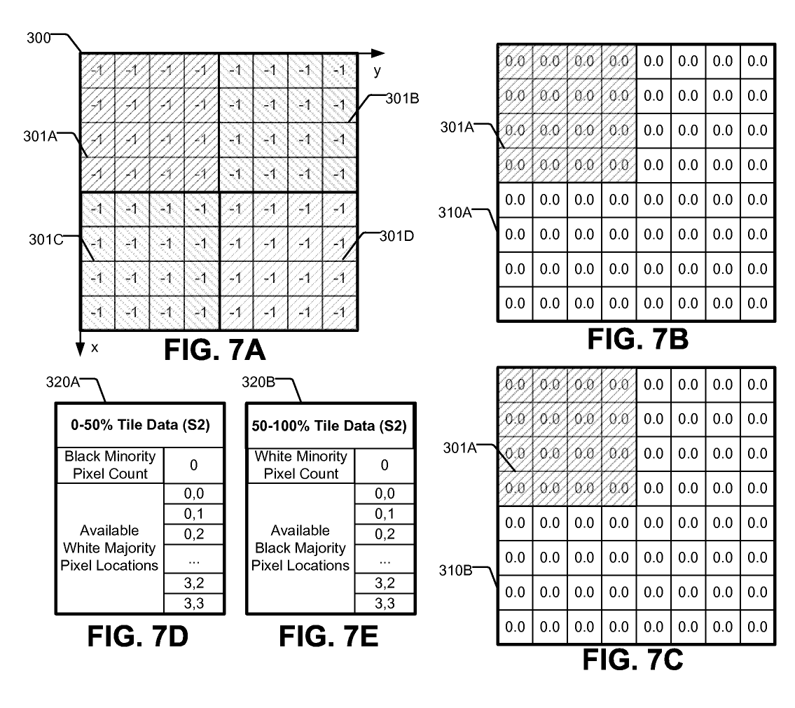

FIG. 6 is a flow chart diagram illustrating an exemplary method for generating a stochastic screen based on screening parameter values and a parameterized screening algorithm. The method can be performed by screen generator 31 according to one embodiment of the invention. According to a preferred embodiment of the invention, screen generator 31 can generate a user-defined stochastic screen quickly enough that an acceptably small latency is introduced in image processing carried out by RIP 20. Table 1 illustrates times recorded for generating user-defined stochastic screen threshold arrays of varying sizes using a desktop computer with a Core 2 CPU 6600 @ 2.4 GHz and 3.37 GB RAM and an experimental version of screen generator 31. Note that the algorithm exhibits a processing time on the order of N*LN(N) so that even larger arrays can be produced relatively quickly. Experience has shown that larger arrays can produce better reproduction results when the periodicity of a typically sized array introduces unwanted artifacts. For example, for 2400 DPI pixels, tiles sizes of at least 1,000,000 can be preferred.

TABLE 1
Exemplary Threshold Array Generation Times

| | Number Of | N * LN(N)/ | Time To Generate |
|---|---|---|---|
| Array Size | Pixels (N) | 600000 | (seconds) |
| 100 × 100 | 10,000 | 0.2 | 0.1 |
| 200 × 200 | 40,000 | 0.7 | 0.2 |
| 300 × 300 | 90,000 | 1.7 | 0.5 |
| 400 × 400 | 160,000 | 3.2 | 1.1 |
| 500 × 500 | 250,000 | 5.2 | 2.1 |
| 600 × 600 | 360,000 | 7.7 | 4.0 |
| 700 × 700 | 490,000 | 10.7 | 6.9 |
| 800 × 800 | 640,000 | 14.3 | 11.0 |
| 900 × 900 | 810,000 | 18.4 | 16.6 |
| 1000 × 1000 | 1,000,000 | 23.0 | 24.3 |

An exemplary method for generating a screen is now described with reference to FIGS. 6-8. Central to the method of FIG. 6 is a set of shaping functions that describe a cost (e.g. a force) exerted by a minority pixel at nearby majority pixel locations. In general, the next minority pixel is identified as one whose pixel location has a minimum cost (e.g. force) value. For the purposes of this disclosure, a minority pixel comprises a black pixel in the tonal range from 0%-50% and a white pixel in the tonal range from 50%-100%. A majority pixel is the opposite of a minority pixel.

One exemplary set of basic shaping functions is illustrated in Table 2. Shaping functions S1-S4 operate relative to a radius (R) from a newly identified minority pixel. The radius is computed as the Euclidian distance from the center of a device pixel in a mainscan (x) direction and a subscan (y) direction.

TABLE 2
Exemplary Basic Shaping Functions

| | | Max | Min. | Tile |
|---|---|---|---|---|
| Id | Function(Radius) | Radius | Separation | Size |
| S1 | exp(−R²/(2 * 8²)) | 24 | 16 | Full |
| S2 | exp(−R²/(2 * 4²)) | 12 | 8 | ¼ |
| S3 | ¼ * exp(−R²/(2 * 8²)) + f₁ | 24 | 4 | 1/16 |
| S4 | ½ * exp(−R²/(2 * 4²)) + f₂ + f₃ | 12 | 0 | 1/64 |

| | |
|---|---|
| f₁ | exp(−R²/(2 * 2²)) where \|R\| ≦ 6 |
| | or |
| | 0 where \|R\| > 6 |
| f₂ | exp(−R²/(2 * (1.5)²)) where \|R\| ≦ 4 |
| | or |
| | 0 where \|R\| > 4 |
| f₃ | −0.6 where (\|x\| = 1 & \|y\| = 0) or (\|x\| = 0 & \|y\| = 1) |
| | or |
| | −0.45 where (\|x\| = 1 & \|y\| = 1) |
| | or |
| | 0 otherwise |

S1-S4 each exert a repulsion force that diminishes as the radius increases. These tend to disperse minority pixels in a uniform fashion. S4 exerts a reduced repulsion force at pixels adjacent to the minority pixel which favors clustering there when dispersion becomes difficult. Shaping functions S1-S4 are used to compute a force field value at majority pixel locations with an area bounded by a maximum radius specified for each function.

According to one embodiment, one function is selected for computing force field values at a time. Selection is based on a dynamically computed average separation for minority pixels and a minimum separation specified for each function. When few minority pixels have been selected at low tone values, the average separation is relatively large and S1 is selected. As minority pixels are added, the average separation reduces and S2-S4 are selected in order. In some embodiments, when switching from one function to the next, unselected force field array values can be re-initialized so that selection of minority pixel locations is only based only on the current function.

S3 and S4 incorporate subordinate functions f1-f3. Function f3, for example, provides for the reduced force field value proximal the minority pixel. Tile size is described below. Note that S1-S4 are Gaussian functions but other types of functions that diminish as radius increases can be appropriate.

S1-S4 characteristics were empirically determined to produce visually pleasing dot profiles at constant tone levels. Using a subset of functions, such as S1-S4 without f3, produces visually pleasing blue noise dot profiles while using S1-S4 produces visually pleasing green noise dot profiles. S1-S4 can be a starting point for parameterized shaping functions that are described further below. For clarity, shaping functions S1-S4 will be used to describe the method of FIG. 6.

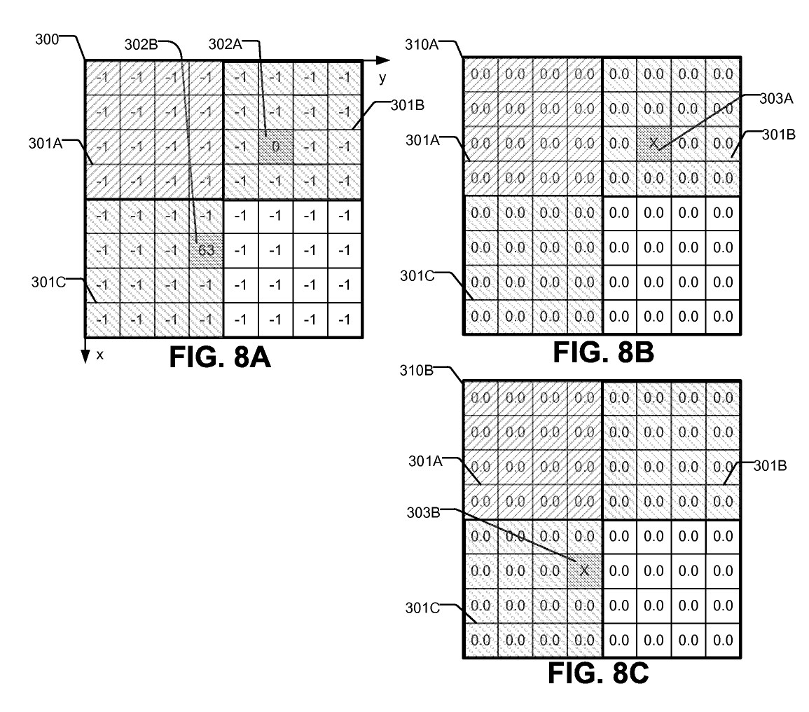

The method of FIG. 6 begins at block 220 and immediately proceeds to block 222 where data for the method is initialized. The data can include a threshold array 300 (FIG. 7A) of a size specified by the user, two force field value arrays 310A and 310B (FIGS. 7B and 7C) of the same size as the threshold array (one for each type of minority pixel) and two sets of tile data 320A and 320B (FIGS. 7D and 7E) for each tile specified by a shaping function. Threshold array 300 is sized according to a user-defined Pixel Aspect Ratio parameter and a threshold array size parameter (see Table 3 below). Each pixel location can include storage for a 16-bit threshold array value and is initialized to a null value (e.g. −1). Force field arrays 310A and 310B can be of the same size as threshold array 300 and include storage at each pixel location for a real number force field value, initially set to a 0 value.

Tiles 301 are identified at block 222 based on the computed size of the threshold array 300 and the tile size data of the corresponding shaping function. For example, one tile (not shown) can be created for S1, representing the entire threshold array 300 for both halves of the tonal range, and four tiles 301A-301D can be created for S2, each representing a quarter of the threshold array 300 for both halves of the tonal range. For each tile 301A-301D, such as exemplary tile 301A, tile data 320 is created for each half of the tonal range. Each tile data 320A, 320B includes a count of the number of minority pixels currently assigned in the associated part of the threshold array (e.g. non-zero threshold array value). Tile data 320A, 320B can also include a list of available majority pixel locations that are preferably sorted by the force field values from corresponding locations in the associated force field array 310A, 310B.

For example, tile 301A, shown with a hatched fill, is identified as one of four tiles associated with S2 and in association with arrays 300, 310A and 310B of FIGS. 7A-7C. Tile data 320A and 320B is created for tile 301A and initialized to indicate no minority pixels are selected and all majority pixel locations within the tile are available for selection as a new minority pixel. The initial sorting order is arbitrary.

Finally at step 222, the number of tonal steps can be determined based on the number of pixels identified for threshold array 300. For the example of threshold array 300, the first tonal step will be 1/64 or 1.5625%, and the second last step will be 63/64 or 98.4375%. In practice, much larger arrays, on the order of 1000×1000 pixels may be desired which allow for much finer steps (e.g. 0.0001%). As another alternative, a tone step size can be established as a predefined or user-defined value (e.g. 0.1%) and a corresponding number of pixels (e.g. 1000) can be identified for each tone step in the 1000×1000 array. Each tone step includes approximately the same number of minority pixels with the same threshold array value. The number of pixels per step may not be the same if the threshold array size is not an integer multiple of the tone step size.

Table 3 describes an exemplary set of user-defined screen generation parameters that can be used with a set of shaping functions with or adapted from S1-S4. The relevance of each parameter is described below in the context of their usage.

TABLE 3
Exemplary Screen Generation Parameters

| Parameter | Values | Meaning |
|---|---|---|
| Pixel Aspect | Integer | Describes the aspect ratio of device |
| Ratio | | pixels (mainscan/subscan). |
| Threshold Array | Integer | The number of pixels. For square |
| Size | | arrays the size can be specified as the |
| | | mainscan dimension. The size can |
| | | then be inferred from the Pixel Aspect |
| | | Ratio. |
| Seed Tone Step | Percentage | Defines the tonal level step above 0% |
| | | and below 100% that seed pixels |
| | | should represent. |
| Max Seed Noise | Percentage | Defines the maximum radial |
| | | dislocation of a seed minority pixel |
| | | from its nominal position. |
| Cluster Shaping | Real | A standard deviation factor for |
| | | difference of Gaussian functions used |
| | | to control the degree of clustering in |
| | | the mid-tones. |
| Diagonal Bias | Real | The diagonal bias to apply in shaping |
| | | functions to correspond with an |
| | | anticipated human visual response. |
| Cluster Size | Integer | The minimum number of device pixels |
| | | on each side of a clustered dot. |
| Anticipated Dot | Percentage | The expected dot gain used by the dot |
| Gain | | gain model incorporated into the |
| | | shaping functions. |
| Edge/Area | Real | The desired average ratio of generated |
| | | halftone dot perimeters to their areas |
| | | at 50% tonality. |

Having completed initialization, the method proceeds to block 224 where seed pixels can be established for the first and second last tonal steps. The user-defined seed tone step parameter can identify how many seed pixel pixels should be established. Both black minority pixels above 0% and white minority pixels below 100% for this step can be established as seed pixels. A default value of 0.2% can be established, as an example, in lieu of a user-defined value. Note that the description that follows is based on the assumption that screen data for both the high and low tonal ranges are simultaneously built for each tonal step. Other methods, where different parts of the tonal range are built in sequence can be accommodated by the invention.

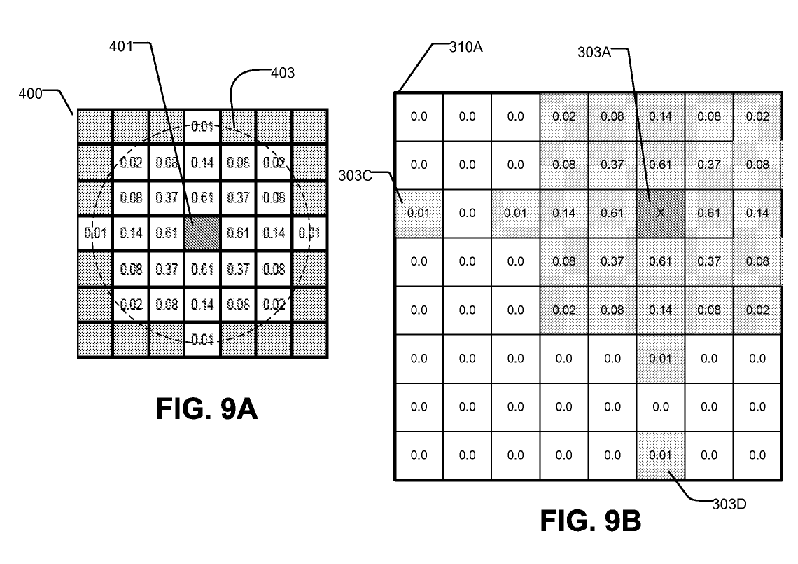

The distribution of seed pixels can be established by uniformly distributing the seed pixels according to a Bayer dither (i.e. regular dispersion) pattern. In one embodiment, a degree of randomness can be introduced to the Bayer dither pattern locations to reduce the anisotropy of the screen at low tone levels. For example, each minority seed pixel can be shifted by some randomized radial distance at a randomized angle. The user-defined max seed noise parameter is used to limit the magnitude of a randomized radial shift in each seed pixel location. FIG. 8A illustrates threshold array 300 updated with two exemplary seed minority pixels established. Minority pixel 302A has threshold value 0 corresponding to the first black minority pixel and minority pixel 302B has threshold value 63 corresponding to the first white minority pixel. Note that, for illustrative clarity, seed minority pixels 302A and 302B are not shown on a randomized Bayer grid.

When a minority pixel 302A, 302B is identified, information in corresponding force field array 310A-, 310B and each tile data 320A, 320B (for each tile 301A-301D) can be updated. For example, selecting black minority pixel 302A can result in force field value 303A in force field array 310A (FIG. 8B) being set to indicate that is no longer eligible for force field calculations. Similarly, “black pixels” count in tile data 320, for tile 301B, is incremented and the location of minority pixel 302A is removed from “white pixel locations” list in tile data 320 for tile 301B. Since a minority pixel 302 can exist in more than one tile 301 (i.e. tiles overlap), each affected tile data 320 should be updated accordingly.

As another example, selecting white minority pixel 302B can result in force field value 303B in force field array 310B (FIG. 8C) being set to indicate that is no longer eligible for force field calculations. Similarly, “white pixels” count in tile data 320 for tile 301C is incremented and the location of minority pixel 302B is removed from “black pixel locations” list in tile data 320 for tile 301C.

The method proceeds next to block 226 where the shaping functions are applied for each minority pixel 302A, 302B that has just been selected. Experiments found that applying shaping functions dominate the utilization of computing resources for the method. In particular, the generation time was on the order of N² for an N×N threshold array.

According to one improved performance embodiment of the invention, each shaping function is used to create one or more masks which can then be positioned relative to the location of a new minority pixel 302 and the mask's values added to current force field values 303 for available majority pixels in a force field array. Each mask can be calculated once and reused throughout the method.

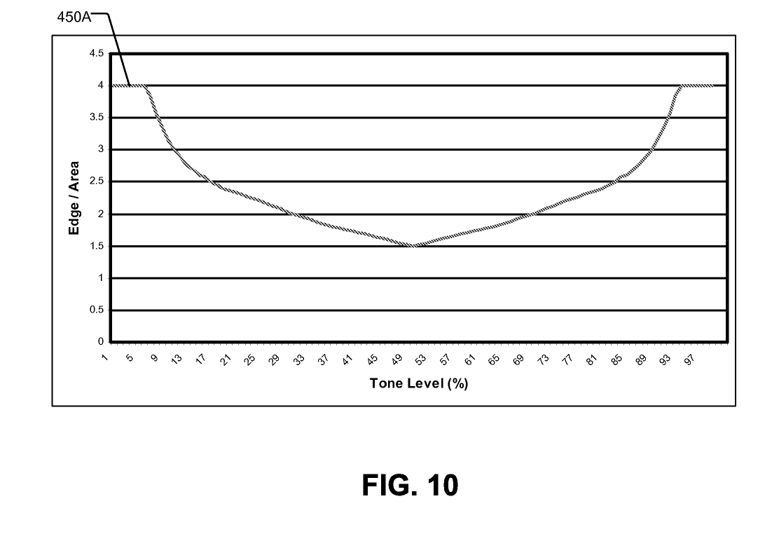

FIG. 9A illustrates an exemplary shaping mask 400 corresponding to shaping function S2 for threshold array 300. Note that S2's radii and exponent divisor values from Table 2 correspond to arrays of a size of at least 200×200 pixels. Since threshold array 300 is small, shaping mask 400 corresponds to a version of S2 that is modified (radii reduce by ¼ and divisor factor 4 reduced by ¼) for illustrative clarity. Mask center 401 corresponds to the position of a newly identified minority pixel. Maximum function radius 403 bounds the pixel positions of force field array 310 that can be updated by mask 400. Pixel positions shown in gray have no (or zero) values, indicating they are outside the evaluation radii of function S2. Pixel positions shown in white have values calculated according to S2.

FIG. 9B illustrates an exemplary update of force field array 310A by shaping mask 400. Logically, mask center 401 is aligned with force field value 303A, corresponding to minority pixel 302A. Then, values from shaping mask 400 are added to coincident force field values 303 of force field array 310A. Updated values 303 are depicted with light gray shading. Similarly (not shown), mask center 401 is aligned with force field value 303B of force field array 310B and values from mask 400 added to coincident field values 303 of array 310B. “Available majority pixel locations” data in corresponding tile data 320A can be re-ordered according to updated force field values 303 for use in a subsequent step.

Note that force field values 303C and 303D were updated by shaping mask 400 so that the resultant screen has good wraparound properties. In one embodiment, that further improves performance by reducing address calculations, the coordinate system of threshold array 300, force field arrays 301A and 301B as well as shaping mask 400 are cylindrical rather than linear.

After applying shaping functions at block 226, the method proceeds to block 228 where a tile 301 is selected as the source of a next minority pixel 302. According to one embodiment of the invention, selection of a tile 301 is based on evaluating the minority pixel count of associated tile data 320. For example, the tile 301 with the lowest minority pixel count can be selected. As another example, if more than one tile 301 has the minimum number of minority pixels one tile 301 can be selected at random from those having the minimum count.

The method proceeds next to block 230 where the next minority pixel 302 is selected from the selected tile 301. According to one embodiment, the location of a pixel can be determined from tile data 320 for selected tile 301. The pixel location from tile data 320 having the minimum positive force field value is chosen as the next minority pixel 302. “Available majority pixel locations” data of tile data 320 can be advantageously used to identify the pixel location if it is sorted as described above. According to one embodiment, if more than one location has a minimum value, one can be chosen at random. According to another embodiment, isotropy can be improved by randomly selecting a location from amongst a subset of available majority pixel locations of a tile having the smallest values. For example, the subset can be identified as some percentage (e.g. 0.2%) of all available pixels for a tile having the lowest values. Thus, as the number of available majority pixel locations is reduced, the subset size decreases and eventually includes only one lowest valued available majority pixel location.

Threshold array 300, force field arrays 301, and tile data 320 are updated based on the location of selected minority pixel 302. Threshold array 300 can be updated with the threshold value for the current tone level. Force field arrays 301 and tile data 320 can be updated as described above. A count of the total number of minority pixels selected for the current tone level is also incremented.

The method proceeds next to block 231 where a decision is made regarding the need to identify additional minority pixels for the current tone step. If additional minority pixels must be identified, the method proceeds to block 228. Note that for blocks 226, 228, 230, and 231, the methods are applied to both black and white minority pixels.

Otherwise the method proceeds to block 232 where a decision is made regarding the need to identify a next tone step. If an additional tone step remains, the current tone levels and threshold values for both tonal ranges are adjusted according to the tonal step size, the minority pixel counts for the current tone level are reset and the method proceeds to block 226.

Otherwise the method proceeds to block 234 where threshold array 300, which now has non-negative values at each pixel location, can be stored as halftone screen 32. As an alternative, threshold array 300 can be compared with each tone level and a corresponding dot profile for each tone level produced. The collection of dot profiles for each tone level can be indexed and stored as halftone screen 32. Halftone screen 32 can be cached for use in subsequent requests that include identical screen parameters 15.

Different embodiments can vary aspects of the method. For example, screen data for the two tonal ranges can be generated serially instead of simultaneously. As another example, different seeding patterns can be established. As another, example, different shaping functions can be used for the lower and upper tonal ranges so that asymmetrical screens are produced. Other exemplary variations in shaping functions are described below.

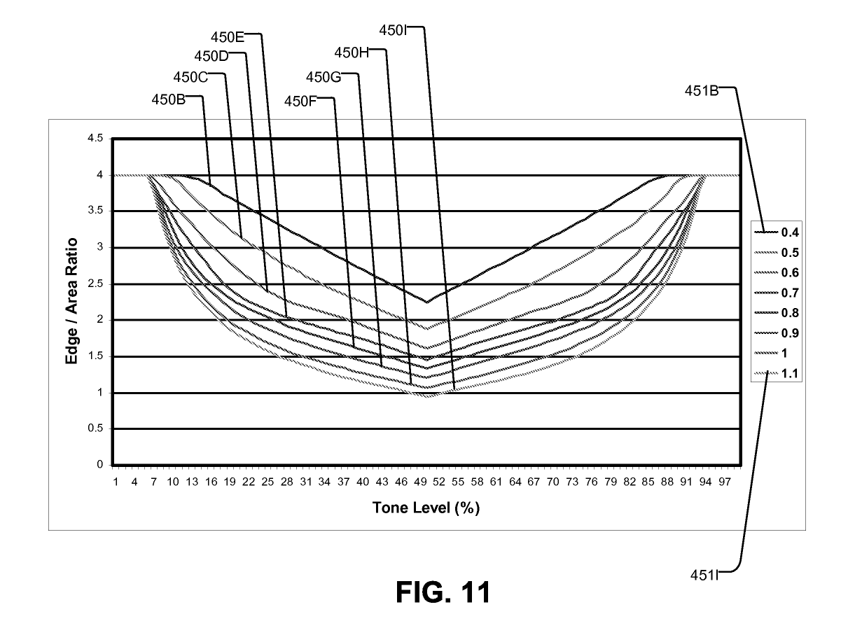

FIG. 10 illustrates an exemplary graph of dot edge/area ratios for a stochastic halftone screen 32 according to one embodiment of the present invention. In particular, graph 450A corresponds to dot profiles produced for a 200×200 pixel screen, generated according to the method of FIG. 6 and shaping functions of Table 2. Graph 450 illustrates that at extreme low and high tone levels, repulsive forces of functions S1-S4 dominate pixel selection and isolated pixels are formed with a corresponding edge/area ratio of 4:1. It also illustrates that as tone levels move closer to the 50% value, pixels begin to cluster so that edge/area ratio is reduced. The reduced repulsive force of function f3 helps the clustering process begin sooner and achieve a comparatively small edge/area ratio throughout the mid-tone range.

Corresponding power spectra and anisotropy graphs (not shown) indicate that the screen produces isotropic dot profiles with green noise power spectra. Experiments have shown that halftone images produced with this screen will be relatively insensitive to process variations and will produce visually pleasing results. It may be desirable, however, to control the shape of the edge/area ratio curve for a screen.

In one embodiment of the present invention, the shaping functions are modified according to Table 4 to allow greater user-defined control.

TABLE 4
Exemplary Enhanced Shaping Functions

| | | Max | Min. | |
|---|---|---|---|---|
| Id | Function(Radius) | Radius | Separation | Tile Size |
| E1 | exp(−R²/(2 * (8 * C)²)) | 3 * (8 * C) | 2 * (8 * C) | 200 × 200 |
| E2 | exp(−R²/(2 * (6 * C)²)) | 3 * (6 * C) | 2 * (6 * C) | 100 × 100 |
| E3 | exp(−R²/(2 * (4 * C)²)) | 3 * (4 * C) | 2 * (4 * C) | 75 × 75 |
| E4 | ¼ * exp(−R²/ | 3 * (8 * C) | 2 * (2 * C) | 50 × 50 |
| | (2 * (8 * C)²)) + g₁ | | | |
| E5 | ½ * exp(−R²/ | 3 * (4 * C) | 0 | 25 × 25 |
| | (2 * (4 * C)²) + g₂ − g₃ | | | |

| | |
|---|---|
| g₁ | exp((−R/(2 * 2 * C))²) |
| g₂ | exp(−R²/(2 * (2 * σ)²)) |
| g₃ | K * exp(−([1 − α * \|sin(2 * θ)\|)] * R²)/(2 * σ)²) |

Enhanced shaping functions E1-E5 incorporate a number of changes relative to basic functions S1-S4. Firstly, tiles 301 are of a fixed instead of a proportional size since most practical tiles are at least 200×200 pixels. Secondly, cluster shaping parameter (σ) is introduced in g₂ and g₃ to provide user control over the onset of pixel clustering. This is discussed in more detail below. Thirdly, a model of the human visual response (e.g. contrast sensitivity function) is incorporated into g₃ through the use of parameters K, α, and θ. Empirical tests have shown that a value for K of 1.46 produces good results that are similar to S1-S4. In some embodiments, it may be desirable to allow this scalar value to be adjusted. θ represents a radial angle from a minority pixel to a majority pixel location. Use of a sin2θ term causes g₃ to preferentially cluster pixels with a diagonal orientation.

Diagonal bias parameter (α) can be user-defined but defaults to a value of 0.19. Lastly, the size of halftone dots is controlled by a user-defined cluster size (C) parameter. Cluster size can be limited to values of 1, 2 or 3, representing 1×1, 2×2 and 3×3 clusters, for example. Cluster size may be useful for reproduction processes where high addressability exists but where dots below a certain size cannot be faithfully reproduced.

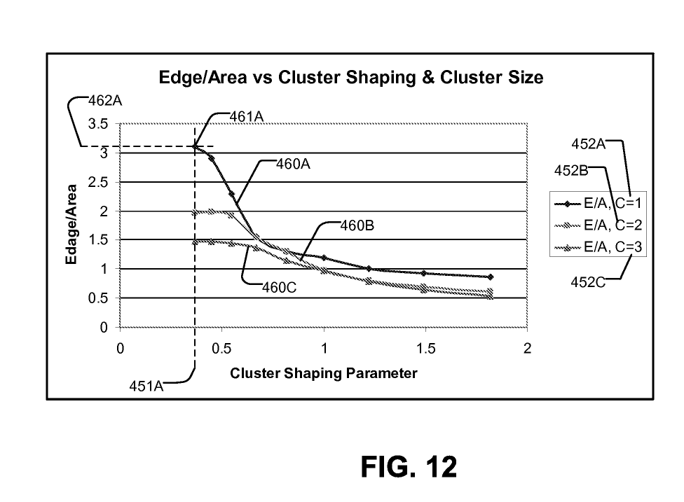

FIG. 11 illustrates an exemplary set of graphs of average dot edge/area ratios for a set of stochastic halftone screens 32 produced with varying cluster shaping parameter (σ) values. Graphs 450B-450I, correspond to a plurality of screens 32 generated using functions E1-E5 with a cluster size parameter value of 1 and a corresponding plurality of cluster shaping parameter values 451B-451H. Although cluster shaping parameter 451B-451I can be useful as an input parameter, a user may prefer to specify a desire effect, such as edge/area ratio as an input parameter, instead of a cause, such as cluster shaping parameter.

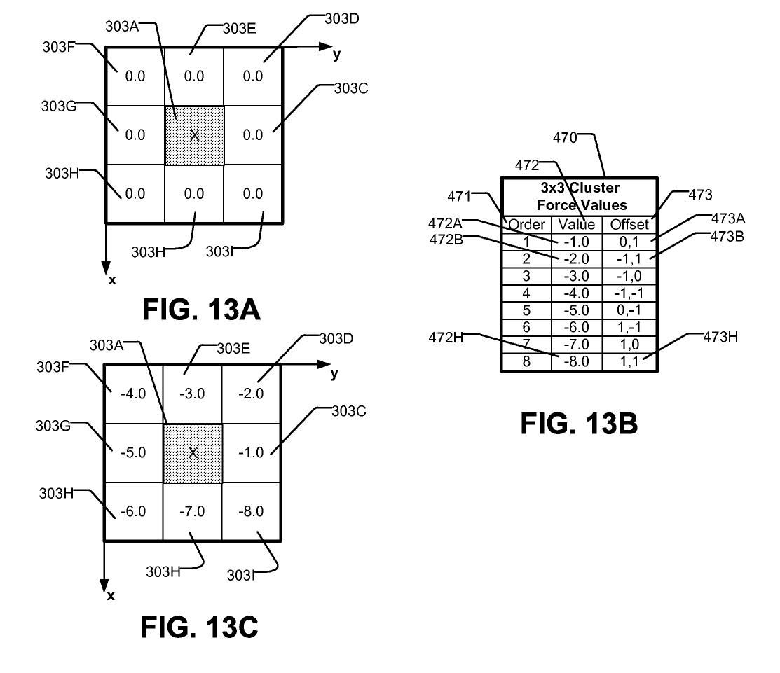

FIG. 12 illustrates exemplary graphs relating edge/area ratio values with cluster shaping parameter values. Graphs 460A-460C were generated as curve fits through a set of empirical data points. Each graph 460A-460C corresponds to a fixed cluster size parameter value. Each data point represents an averaged edge/area ratio at 50% tonality for five tile sizes generated using cluster shaping parameter with a fixed cluster size parameter value. For example, data point 461A corresponds to an averaged value for edge/area ratio parameter 462A of 3.11 when using a value for cluster sizing parameter 451A of 0.367 and a cluster size of 1. Screen generator 31 can use graphs 460A-460C to derive values for cluster shaping parameter 451A based on a user-defined value for averaged edge/area ratio parameter 462A and cluster size parameter 452A.

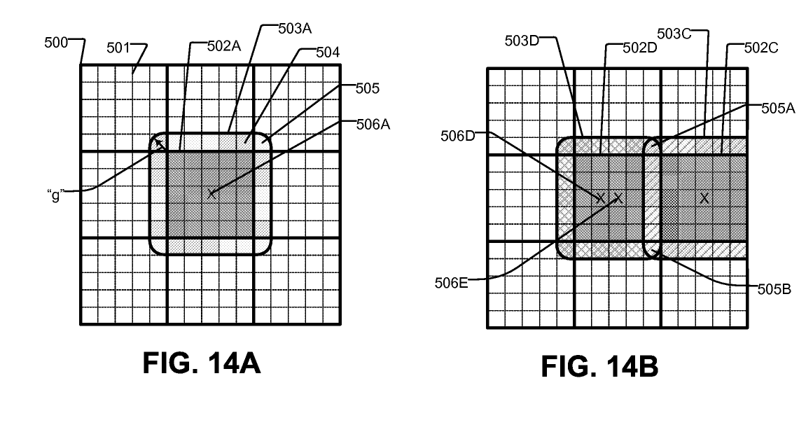

When a user defines a cluster size parameter 452A-452C (e.g. value 3 defining a 3×3 cluster size), the method of FIG. 6 can be adapted to prefer that halftone dots grow from isolated pixels to clusters of the specified size before new isolated minority pixels are identified. FIG. 13A illustrates a portion of a force field array 310A corresponding to an exemplary isolated black minority pixel 302A. For example, force field value 303A, corresponding to new minority pixel 302A, is depicted with neighboring force field values 303C-303I. Assume that the preferred order for growing the halftone dot from minority pixel 302A is counter clockwise from the pixel corresponding to force field value 303C to the pixel corresponding to force field value 303I.

FIG. 13B illustrates an exemplary data structure 470 that can be used to accomplish this. Data structure 470 corresponds to a 3×3 cluster size and can be predefined or user-defined. Similar data structures can be defined for different cluster sizes. Pixel growth order 471 is specified for the cluster relative to a reference pixel location (e.g. corresponding to force field value 303A). According to one embodiment, negative force field values 472 of increasing magnitude are specified for each growth pixel location. Negative force field values 472A-472H can be factors applied to a weighting factor (not shown), so that large negative values are established. Growth pixel locations for applying negative force field values 472A-472H are specified by offsets 473A-473H, relative to the reference pixel location.

FIG. 13C illustrates the effect of applying data structure 470 to force field array 310 for reference pixel corresponding to force field value 303A. This can be done, for example, using a mask at block 226 of FIG. 6 after applying the shaping functions. Note that negative force field values can be added to existing force field values 303, as with shaping function masks.

A corresponding change must be made to blocks 228 and 230 so that tiles with negative force field values are selected preferentially and that majority pixel value locations with negative force field values are preferentially selected as minority pixels and that locations with small negative values are selected before those with large negative values. The algorithm can require, for example, that each halftone dot is grown to a cluster size before another halftone dot is grown. As an alternative, the algorithm can require that halftone dots are grown in parallel (e.g. according to the magnitude of negative force field values).

Referring again to FIG. 12, graphs 460B and 460C illustrate exemplary curves used to derive values for cluster shaping parameter 451 for user-defined values of averaged edge/area ratio parameter 462 and cluster size parameter 452. These curves were also fit to empirically determined data points for a variety of tile sizes.

Empirical tests made with screens generated using enhanced shaping functions E1-E5 showed that some improvements in mid-tone graininess could still be made. In one embodiment, the application of shaping functions E1-E5 at block 226 was further adapted to take into account anticipated dot gain of minority pixels. Anticipated dot gain can be measured, for example, by reproducing test images and measuring effective dot gain of the overall reproduction process. The anticipated dot gain can be used in conjunction with shaping function E1-E5 to adjust the intensity and position of a force field exerted by a minority pixel and thus alter the manner in which the dots are dispersed.

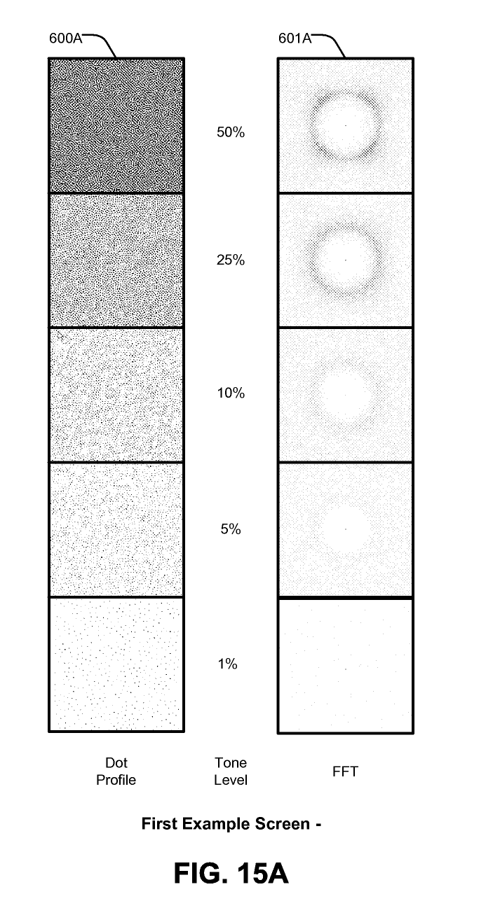

FIG. 14A illustrates an exemplary model of minority pixel dot gain according to one aspect of the invention. Nominal pixel grid 500 is illustrated with thick lines. For illustrative purposes only, nominal pixel 502A is depicted as being subdivided by sub-pixel grid 501 into 25 equal areas. For example, enabled pixel 502A is illustrated with a dark color having 25 units of area.

After dot gain, pixel 502A grows to a size depicted by gained pixel 503A. The model for gained pixel 503A includes a number of gained edge areas 504 and a number of gained corner areas 505. In the example of FIG. 14A, edges of pixel 502A grow by an amount “g”, having a value of 1 unit. Thus, each depicted gained edge area 504 includes 1 unit of area for a total gained edge area of 20 units. Each gained corner area 505 includes πg²/4 or approximately 0.78 units for a total gained corner area of 3.14. Thus, the modeled area of gained pixel 503A is 23.14+25=48.14 units or an area that is 1.93 times that of nominal pixel 502A.

Each of shaping functions E1-E5 is based on a pixel having a unit area. With dot gain, each function can be modified to include a dot gain weighting factor that is computed for each minority pixel as it is identified (e.g. in blocks 224 and 230). For example, shaping function E1 for gained pixel 503A becomes 1.93*exp(−R²/(2*(8*C)²)). Modeled dot center 506A of gained pixel 503A is the same as that for nominal pixel 502A since modeled growth is symmetrical.

FIG. 14B illustrates another exemplary model of minority pixel dot gain according to one aspect of the invention. In this example, gained minority pixel 503C has been previously identified and can be taken into consideration when determining the modeled dot gain of pixel 502D. In this case, the gained area already covered by pixel 502C is illustrated with light gray diagonal hatching. Note that 503C's gained area overlaps 20% of the area of nominal pixel 502D and practically all of two gained corner areas 505A and 505B of gained pixel 503D.

The area of gained pixel 503D includes reduced nominal area, illustrated with dark color, and gained area, illustrated with light gray cross hatching. Thus, the area of gained pixel 503D is modeled as 4×5 units (reduced nominal area)+[4+5+4] units (gained edge area)+2*0.78 units (gained corner area). The total area of gained pixel 503D is summed as 34.56 units. This area is 1.38 times the nominal area of 25 units of nominal pixel 502D and this dot gain weighting factor can be used with shaping functions E1-E5.

Modeled dot center 506D is shifted left from the nominal dot center 506E of nominal pixel 502D because of the asymmetric gain and reduced nominal area. The position of modeled dot center 506D can also be used in shaping function E1-E5 to achieve a more homogenous dispersal of dots. Dot gain weighting factor and modeled dot center values can be calculated at block 222 based on various combinations of enabled adjacent pixels and the calculated elements reused to improve performance. According to one embodiment, multiple masks for each function, corresponding to permutations of modeled dot centers and gain factors, can be pre-computed to further enhance performance.

The value for edge growth “g” can be derived from the user-defined anticipated dot gain parameter. For example, for a square pixel of unit edge length, anticipated dot gain is equated with (4g+πg²)*100%, which can be solved for “g” and this value used to compute weighting factors and dot gain centers. For pixels with rectangular aspect ratios, anticipated dot gain can be equated with a different formula based on edge growth “g.”

Different models of dot gain can be used, but this particular model was empirically determined to be effective for halftone imaging devices 40 that produce rectangular dots by exposing pixels with steep exposure profiles. For example, a circular model of dot gain could be advantageous for devices 40 that produce round dots with Gaussian exposure profiles.

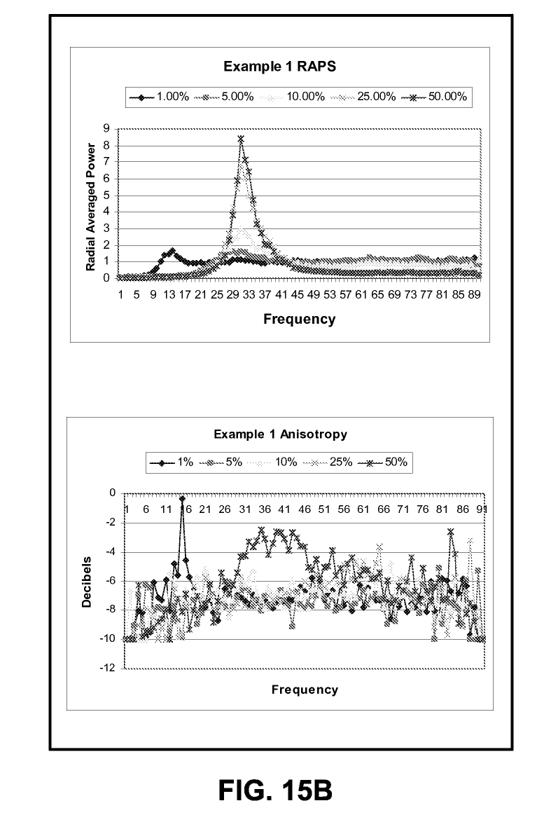

FIGS. 15-23 illustrate characteristics for a series of example screens generated from a variety of user-defined parameters. Table 5 lists default screen generation parameters for the examples, which were used in conjunction with shaping functions E1-E5 to produce threshold arrays 300. Each example varies one or more of these parameters to produce a unique threshold array 300. For each example, figures are provided which illustrate one or more of the following:
Dot profiles at various tone levels (e.g. 1%, 5%, 10%, 25% and 50%);
Fast Fourier transform (FFT) plots for various dot profiles illustrating 2-dimensional power spectra;
Radially averaged power spectra (RAPS) plots for various dot profiles;
Anisotropy plots for various dot profiles; and
Edge to Area plots vs. Tone Level.

TABLE 5
Default Screen Generation Parameters

| Parameter | Values |
|---|---|
| Pixel Aspect Ratio | 1 |
| Threshold Array Size | 256 * 256 |
| Seed Tone Step | 0.2% |
| Max Seed Noise | 20% |
| Cluster Shaping | Computed from |
| | Edge/Area |
| Diagonal Bias | 0.19 |
| Cluster Size | 1 |
| Anticipated Dot Gain | 0% |
| Edge/Area | 1.5 |

FIG. 15A illustrates a first exemplary screen generated by the default parameters of Table 5. Dot profiles 600A and FFTs 601A are shown for a set of tone levels. Dot profiles 600A show that halftone dots grow from isolated pixels at 1% tone to clustered structures having a diagonal bias at 50% tone. FFTs 601A illustrate power values as a function of frequency in two dimensions, with the DC power (center of each plot) eliminated. Black dots indicate larger power values than gray or white dots. FFTs 601A show that power is concentrated in the mid-frequency ranges, especially at higher tone levels, and that power is approximately radially symmetric (i.e. isotropic). At higher tone levels, a slight concentration of power at diagonal frequencies can be seen. This is due to the model of human contrast sensitivity incorporated in function g₃ which is biased to place screen noise where the human eye cannot easily see it.

FIG. 15B illustrates RAPS and anisotropy plots for the first exemplary screen. They are consistent with the appearance of FFTs 601A since radially averaged power peaks in the mid-frequency band and negative anisotropy indicates a relatively symmetric and homogenous distribution of radially averaged power at different frequencies. FIGS. 15A and 15B are consistent with a fine-grained, isotropic green noise screen having good wraparound properties and optimized for human visual responsiveness. The screen of example one could be useful for a high addressability CTP and offset printing requiring fine screens, but not so fine that they cause imaging or lithographic issues.

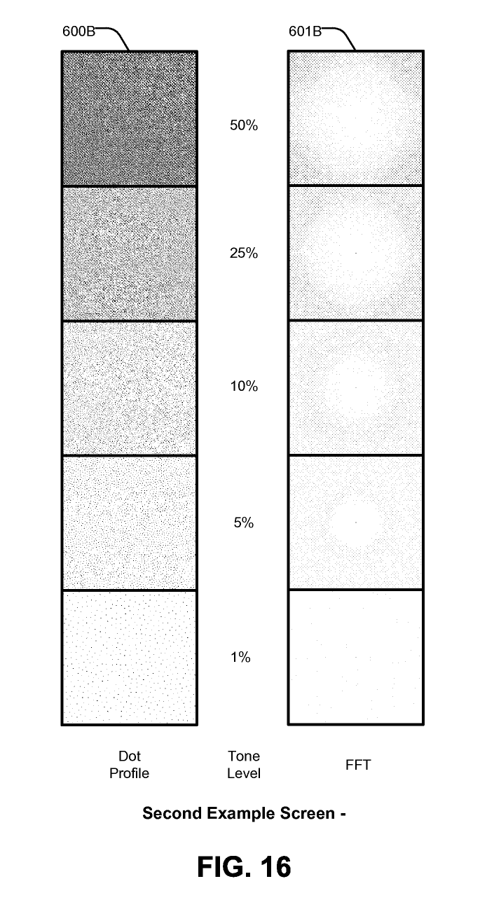

FIG. 16 illustrates a second exemplary screen, which differs from the first example screen by being based on an edge/area ratio parameter value of 2.9 instead of 1.5. Dot profiles 600B show that a greater percentage of isolated pixel halftone dots exist at higher tone levels which is consistent with a reduced effect of function E5. Similarly, note that dot profiles 600B at higher tone levels have a reduced diagonal bias as well. FFTs 601B show that there is a greater concentration of power at higher frequencies, especially at higher tone levels. FIG. 16 depicts dot profiles 600B and FFTs 601B that are more consistent with an isotropic blue noise screen having good wraparound properties and optimized for human visual responsiveness. The screen of example two could be useful for a very high resolution CTP and offset printing process or lower resolution processes such as inkjet and electro-photographic which produce good results with non-periodic screening with the large high frequency power spectra components.

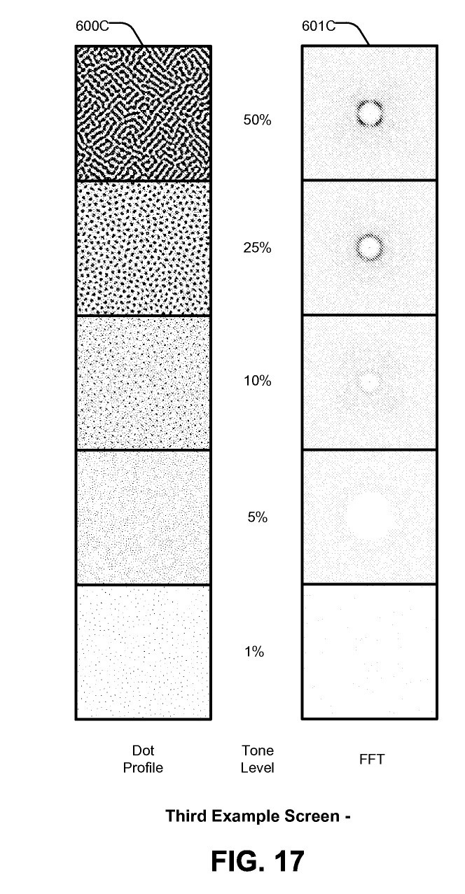

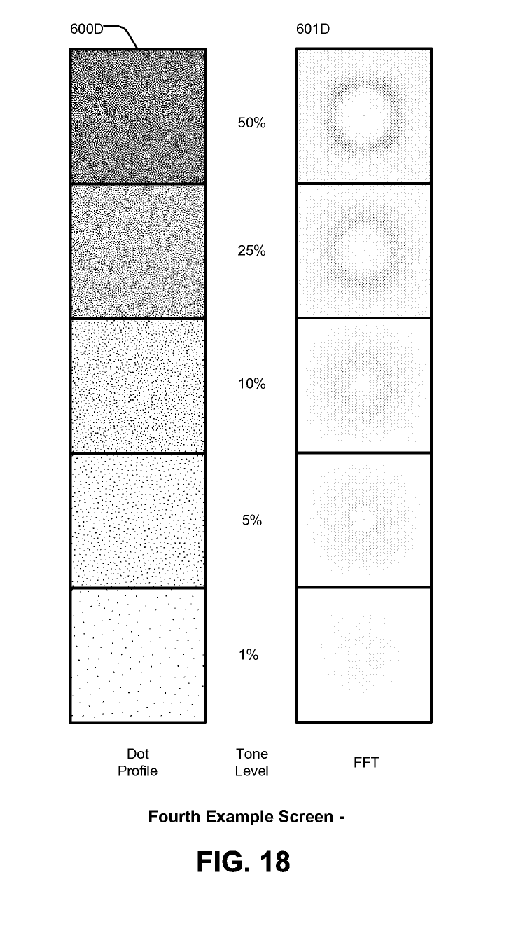

FIG. 17 illustrates a third exemplary screen, which differs from the first example screen by being based on an edge/area ratio parameter value of 0.5 instead of 1.5. Dot profiles 600C and FFTs 601C show and even more pronounced clustering of pixels into halftone dots as expected given a request for lower edge/area ratios. The screen of example three could be useful for a highly variable reproduction process, requiring larger structures having greater latitude to variation, FIG. 18 illustrates a fourth exemplary screen, which differs from the first example screen by being based on a cluster size parameter having a value of 2 instead of 1. Dot profiles 600D and 600A are very similar at higher tone levels as halftone dots are clustering together. In contrast, at low tone levels, dot profiles 600D include mostly larger halftone dots that are more widely dispersed. Dot profiles 600D and FFTs 601D are consistent with a coarser green noise screen. The screen of example four could be useful for a high resolution printing system restricted by lower resolution CTP plate and/or CTP device.

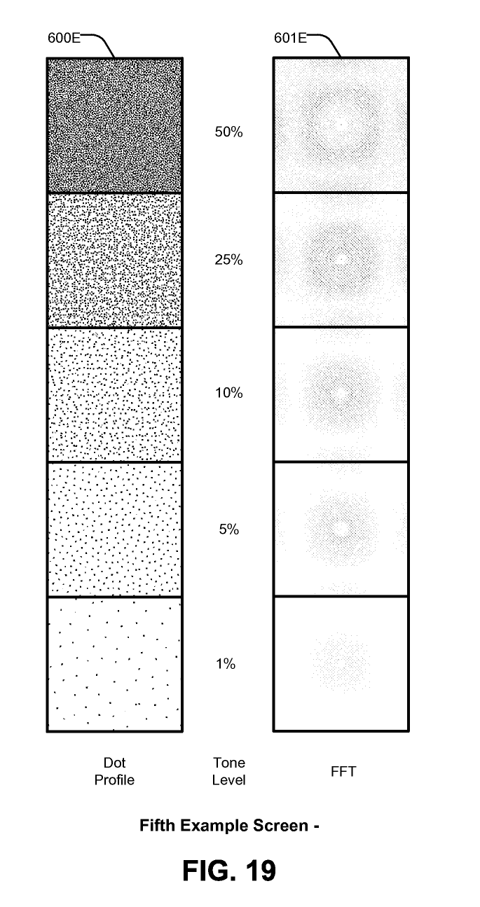

FIG. 19 illustrates a fifth exemplary screen, which differs from the first example screen by being based on a cluster size parameter having a value of 3 instead of 1. Dot profiles 600E and FFTs 601E include much larger halftone dots that are relatively dispersed at almost all tone levels (clustering is just beginning at 50% level). The screen of example five could be useful for a corrugated cardboard, directory, newspaper, or flexography.

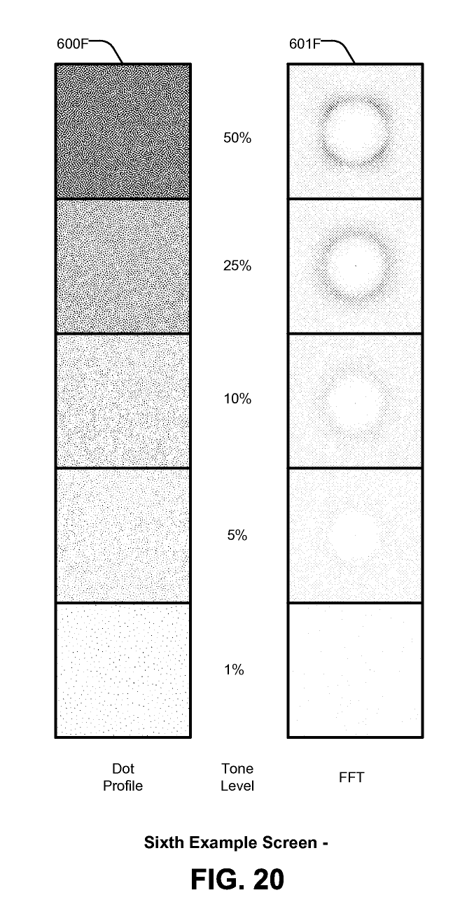

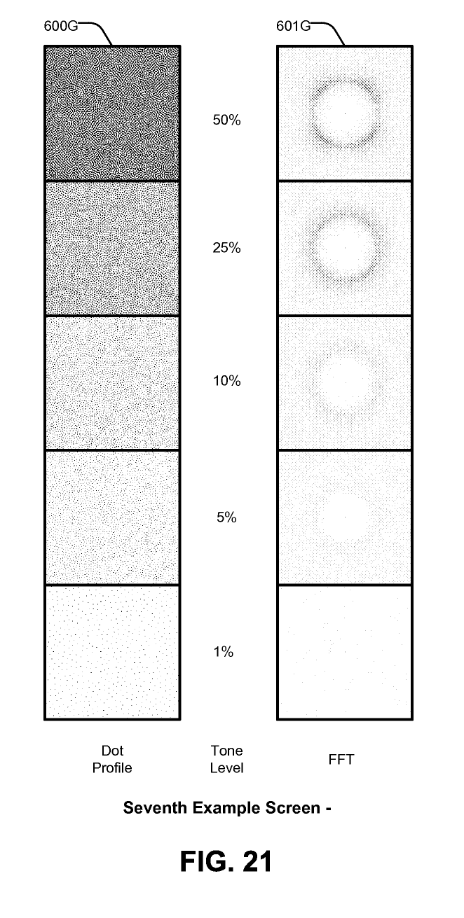

FIGS. 20 and 21 illustrate respectively sixth and seventh exemplary screens, which differ from the first example screen by being based on an anticipated dot gain parameter having a value of 10% and 20% respectively instead of 0%. It is difficult to see the differences in dot profiles 600F and 600G relative to 600A. Similarly, FFTs 601F and 601G are similar to FFT 601A.

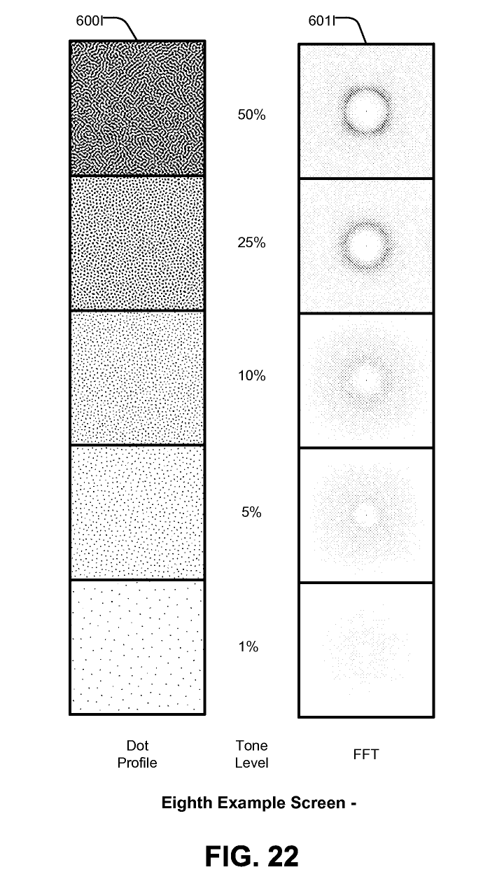

FIG. 22 illustrates an eighth exemplary screen, which differs from the first example screen by being based on an edge/area ratio having a value of 1.0 instead of 1.5, a cluster size parameter having a value of 2 instead of 1 and an anticipated dot gain parameter having a value of 20% instead of 0%. Dot profiles 600I and FFTs 601I show a combination of effects described above.

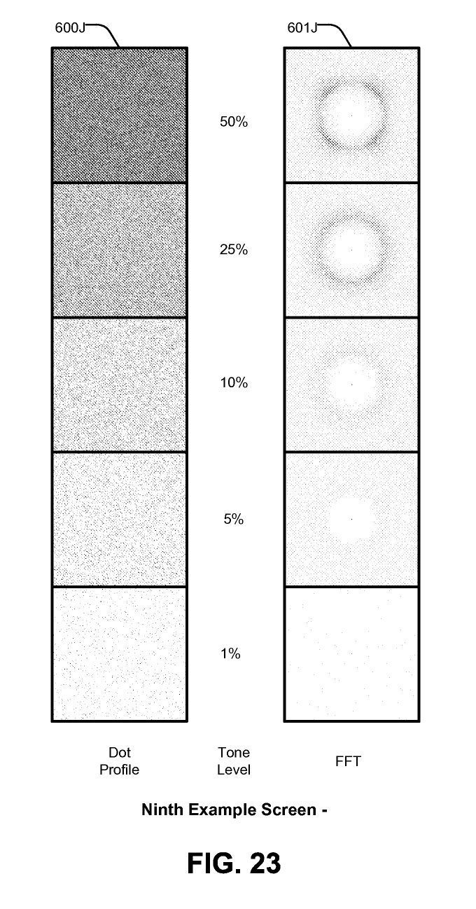

FIG. 23 illustrates a ninth exemplary screen, which differs from the first example screen by being based on a threshold array size parameter having a value of 1500*1500 instead of 256*256. Note that dot profiles 600J appear much finer because of the reduced magnification relative to dot profiles 600A. Note also, that FFTs 601J appear virtually identical to FFTs 601A. The screen of example nine can be useful when the periodicity of the tiled threshold array results in visible artifacts. Experiments have shown that one cause for this is when the tiling frequency modulates with some other significant frequency component of the reproduction process to create a significant low frequency component that is within the visible pass band of the human eye.

In one embodiment, a system including at least RIP 20, screen processor 30 and halftone imaging device 40 are mutually configurable to support a reproduction process where the exposed halftone image has a dimensional constraint.

One exemplary constraint is a repeat length for the exposed halftone image. An example of a process with a repeat length constraint is contiguous printing of an image on a roll of paper (e.g. printing wallpaper). One method for contiguous printing of an image is to expose the halftone image data 24 on a cylindrical blank image medium 41 with a circumference equal to the repeat length. One challenge with this type of process is to ensure that halftone data abutting at the repeat boundary does not produce visual artifacts.

One way to prevent artifacts at the repeat boundary is to ensure that the repeat length dimension is integer divisible by the aligned dimension of a portion of the exposed halftone image corresponding to threshold array 300. Since the dimension of the portion of exposed halftone image is determined by the resolution of halftone imaging device 40 and a dimension of threshold array 300, an optimal solution can be determined by configuring appropriate values for resolution (e.g. at halftone imaging device 40 and RIP 20) and screen parameters affecting the dimension of threshold array 300 (e.g. at screen processor 30 as described above). Variable resolution in prior art RIPs 20 is well known. Variable resolution in halftone imaging devices 40 is less common. Certain models of the Trendsetter, Lotem and Magnus family of CTP devices, manufactured by Eastman Kodak, have this capability by providing a mainscan and/or subscan scaling adjustment in the imaging components.

Selecting the optimal combination of resolution and threshold array dimension can be automated based on certain rules. Alternatively, various solutions can be presented to a user for selection. As another alternative, user input may constrain the optimal solutions. For example, a user could specify a range of desired resolutions or a range of threshold array dimensions.

Another exemplary constraint is an image segment dimension for the exposed halftone image. An example of a process with a segment dimension constraint is lenticular printing where halftone image data is broken into segments and interleaved with other images so that only one of the halftone images (in its entirety) is visible when viewed through an array of lenses at a particular viewing angle. Similar to above, it is desirable that each segment be based on halftone image data 24 generated by an integer multiple of threshold arrays 300.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 device pixel address grid
2 device pixel
3 halftone dot
10 printing system
11 job data
12 contone image
13 processing instructions
14 RIP parameters
15 screen parameters
20 raster image processor (RIP)
21 image interpreter
22 contone renderer
23 halftone generator
24 halftone image data
30 screen processor
31 screen generator
32 halftone screen
40 halftone imaging device
41 blank imaging medium
42 imaged medium
50 medium processor
51 processed medium
60 reproduction device
61 consumables
62 halftone image reproductions
100 device pixel matrix
101 device pixel
102 square halftone dot matrix
103A-103E halftone dot
104A-104E halftone dot
105 halftone dot
106 halftone dot
107 halftone dot
110 area
120 area
200 nominal Gaussian exposure profile
201 increased Gaussian exposure profile
202 switch threshold
203 dot diameter
204 dot diameter
210 nominal steep exposure profile
211 increased steep exposure profile
213 dot dimension
214 dot dimension
220 screen generation method block
222 screen generation method block
224 screen generation method block
226 screen generation method block
228 screen generation method block
230 screen generation method block
231 screen generation method block
232 screen generation method block
233 screen generation method block
234 screen generation method block
300 threshold array
301A-301D tile
302A minority pixel
302B minority pixel
303A-303I force field value
310A force field array
310B force field array
320A tile data
320B tile data
400 shaping mask
401 mask center
403 maximum function radius
450A-450I edge/area vs. tone graph
451A-451I cluster shaping parameter value
452A-452C cluster size parameter
460A-460C edge/area vs. cluster shaping graph
461A data point
462A edge/area value
470 data structure
471 pixel growth order
472 negative force field value
472A negative force field value
472B negative force field value
472H negative force field value
473 growth pixel offset
473A growth pixel offset
473B growth pixel offset
473H growth pixel offset
500 nominal pixel grid
501 sub-pixel grid
502A nominal pixel
502C nominal pixel
502D nominal pixel
503A gained pixel
503C gained pixel
503D gained pixel
504 gained edge area
505 gained corner area
505A gained corner area
505B gained corner area
506A modeled dot center
506D modeled dot center
506E modeled dot center
600A-600J dot profiles
601A-601J FFTs

1. A method for processing an image, the method comprising:
associating a stochastic screening parameter with the image;
dynamically generating a stochastic halftone screen based on the stochastic screening parameter; and
generating stochastic halftone image data by applying the stochastic screen to the image.

2. A method according to claim 1 including reproducing the image based on the stochastic halftone image data.

3. A method according to claim 2 wherein reproducing the image comprises exposing the stochastic halftone image data by an imaging device.

4. A method according to claim 1 wherein the stochastic screening parameter is selected from a group of parameters including:
a dither matrix dimension;
a device pixel aspect ratio parameter;
a dither matrix size;
a cluster shaping parameter;
an edge-to-area ratio parameter;
a human visual response parameter;
an anticipated dot gain parameter;
a halftone seed pattern parameter;
a halftone dot cluster size parameter; and
a shaping function scalar parameter.

5. A method according to claim 4 wherein the stochastic screen parameter is based on a combination of the group of parameters.

6. A method according to claim 1 wherein generating the stochastic halftone screen comprises generating a dither matrix based in part on the stochastic screening parameter.

7. A method according to claim 6 wherein a dither matrix comprises one of a threshold array and a set of dot profiles for a plurality of gray levels.

8. A method according to claim 6 wherein generating the dither matrix includes varying a dimension of the dither matrix based on the stochastic screening parameter.

9. A method according to claim 6 wherein generating the dither matrix includes varying a high frequency screen noise power produced by the dither matrix based on the stochastic screening parameter.

10. A method according to claim 6 wherein generating the dither matrix includes shaping dither matrix noise for an anticipated human visual response based on the stochastic screening parameter.

11. A method according to claim 6 wherein generating the dither matrix includes altering dot dispersion for an anticipated dot gain in a reproduction process wherein altering is based on the stochastic screening parameter.

12. A method according to claim 6 wherein generating the dither matrix includes identifying dither matrix values so that halftone pixels clusters of a minimum size are preferentially formed based on the stochastic screening parameter.

13. A method according to claim 6 wherein the dither matrix has a size large enough to prevent unwanted tiling artifacts.

14. A method according to claim 13 wherein the dither matrix has a size corresponding to at least 1,000,000 pixels for 2400 DPI pixels.

15. A method according to claim 6 wherein a time required for generating the stochastic halftone screen is proportional to the product of the dither matrix size and the natural logarithm of the dither matrix size.

16. A method according to claim 15 wherein a time required for generating the screen for a dither matrix of size 250,000 values is less than 1 second.

17. A method according to claim 1 including caching the stochastic halftone screen in association with the stochastic screening parameter.

18. A method according to claim 1 wherein associating the stochastic screening parameter with the image comprises associating based on input from an end user.

19. A method according to claim 1 wherein associating the stochastic screening parameter with the image comprises associating based on information configured for a job.

20. A method according to claim 2 wherein reproducing the image includes one or more reproduction processes for reproducing a halftone dot from the stochastic halftone image data;
wherein a reproduced halftone dot characteristic varies based on a variation in a reproduction process; and
wherein at least one reproduction process incorporates an element designed to reduce the variation of the reproduced halftone dot characteristic from its intended value for a variation in the reproduction process operating condition.

21. A method according to claim 20 wherein the reproduced halftone dot characteristic comprises a reproduced halftone dot area and wherein the reproduction process characteristic comprises an exposure power of an imaging process.

22. A method according to claim 20 wherein the reproduced halftone dot characteristic comprises a reproduced halftone dot area and wherein the variation in the reproduction process comprises a variation in an image exposure process.

23. A method according to claim 3 wherein exposing the stochastic halftone image data comprises exposing device pixels with sufficient accuracy to support a wider range of stochastic halftone screens.

24. A method according to claim 23 wherein exposing device pixels with sufficient accuracy to support a wide range of stochastic halftone screens comprises exposing with a device pixel resolution of at least 1200 DPI.

25. A method according to claim 24 including exposing with a device pixel addressability of at least 2400 DPI.

26. A method according to claim 23 wherein exposing device pixels with sufficient accuracy to support a wide range of stochastic halftone screens comprises exposing with a device pixel resolution of at least 2400 DPI.

27. A method according to claim 24 including exposing with a device pixel addressability of at least 4800 DPI.

28. A method for reproducing an image, the method comprising:
identifying a dimensional constraint for the image to be reproduced;
satisfying the constraint by computing a dither matrix dimension and halftone image resolution;
dynamically configuring an image processor and imaging device based on the halftone image resolution;
dynamically generating a stochastic dither matrix based on the dither matrix dimension;
generating stochastic halftone image data based on the image and the stochastic dither matrix; and
reproducing the image based on the stochastic halftone image data.

29. A method according to claim 28 wherein the dimensional constraint comprises a repeat length for a contiguously reproduced image.

30. A method according to claim 28 wherein the dimensional constraint comprises an image segment dimension defined by a lenticular lens.

31. A method according to claim 28 wherein satisfying the constraint comprises ensuring that a reproduced dimension of the dither matrix at the halftone image resolution is an integer divisor of the dimensional constraint.

32. A method according to claim 28 where generating a stochastic dither matrix comprises specifying additional stochastic screening parameters to match operating conditions anticipated for reproducing the image.

33. A method according to claim 32 wherein specifying additional stochastic screening parameters comprises specifying one or more of the parameters from the group including:
a cluster shaping parameter;
an edge-to-area ratio parameter;
a human visual response parameter;
an anticipated dot gain parameter;
a halftone seed pattern parameter; and
a halftone dot cluster size parameter.

34. An apparatus for reproducing a halftone image, the apparatus comprising:
a screen generator, operative to:
receive a stochastic screening parameter for an image;
generate a stochastic halftone screen based on the stochastic screening parameter;
supply the stochastic halftone screen to a raster image processor for the image; and
a raster image processor, operative to:
receive processing parameters, the associated stochastic halftone screen and data representing the image; and
generate stochastic halftone image data by applying the stochastic screen and processing parameters to the image data.

35. An apparatus according to claim 34 including an imaging device operative to reproduce the image by exposing the halftone image data on an image medium.

36. An apparatus according to claim 34 including a workflow device operative to:
identify a dimensional constraint for the image to be reproduced;
satisfy the constraint by computing a dither matrix dimension and halftone image resolution;
supply the screen generator with the dither matrix dimension; and
supply the raster image processor with the halftone image resolution.
